(19) United States
(12) Patent Application Publication
(10) Pub. No.: US 2016/0168871 A1
(43) Pub. Date: Jun. 16, 2016

(54) DEVICE FOR REMOVING COVERINGS LAID ON PLANAR SURFACES

(71) Applicant: UZIN UTZ AG, Vaihingen/ Enz (DE)

(72) Inventor: Dieter HAMMEL, Vaihingen/ Enz (DE)

(73) Assignee: UZIN UTZ AG GROUP, Vaihingen/ Enz (DE)

(21) Appl. No.: 14/904,277

(22) PCT Filed: Jun. 20, 2014
(86) PCT No.: PCT/EP2014/063028

§ 371 Date: Jan. 11, 2016

(30) Foreign Application Priority Data
Jul. 12, 2013 (DE) 20 2013 006 273.8

(51) Int. Cl. E04G 23/00; B26D 3/28

(52) U.S. Cl. CPC E04G 23/006; B26D 3/28

(57) ABSTRACT

A device for removing coverings laid on planar surfaces includes a drive unit having a pair of drive wheels and a first drive motor for driving the drive wheels, a motor-driven striking mechanism having a cutting blade and a second drive motor. The cutting blade connects to the second drive motor by a connecting rod. The drive unit and the striking mechanism have an articulated connection which is designed in such a way that the drive unit and the striking mechanism are mounted so as to be rotatable relative to one another.

### FIELD OF THE INVENTION

The present invention relates to a device for removing coverings laid on planar surfaces, comprising a drive unit having a pair of drive wheels, a first drive motor and a transmission for driving the drive wheels, and comprising a motor-driven striking mechanism having a cutting blade and a second drive motor, the cutting blade being connected to the second drive motor by a connecting rod.

### BACKGROUND OF THE INVENTION

Coverings laid on planar surfaces, such as carpets laid on floors, are adhered to their supporting surface in the laid state. The coverings are thereby prevented from slipping and sliding about when being walked on. If such coverings are to be replaced by new coverings as a result of wear and tear or damage, the old coverings must be removed first.

Devices are already known which enable such particular coverings to be removed in pieces or in strips. In this case, a motor-driven, vibrating cutting blade is pushed between the covering and the planar supporting surface. When there are bumps, the cutting blade may not rest on the entire surface of the floor, particularly if parts of the covering get under a drive wheel of the device.

### SUMMARY OF THE INVENTION

One idea of the present invention to provide an improved device for removing coverings laid on planar surfaces which enables the cutting blade to rest on the entire surface of the floor even when the device travels over bumps.

A device for removing coverings laid on planar surfaces comprises a drive unit having a pair of drive wheels and a first drive motor for driving the drive wheels, and comprising a motor-driven striking mechanism having a cutting blade and a second drive motor, the cutting blade being connected to the second drive motor by a connecting rod, wherein the drive unit and the striking mechanism have an articulated connection which is designed in such a way that the drive unit and the striking tool are mounted so as to be rotatable relative to one another. It can thereby be ensured that when the device travels over bumps the drive unit and the striking mechanism are rotatable relative to one another.

It may be provided in some embodiments that the drive unit and the striking mechanism are mounted so as to be rotatable relative to one another about an axis of rotation of the articulated connection which is in parallel with a longitudinal axis of the device. By means of the rotatability of the drive unit and the striking mechanism relative to one another about the axis of rotation of the articulated connection, which is in parallel with the longitudinal axis of the device, the drive unit is rotated about the axis of rotation of the articulated connection, i.e. radially with respect to the longitudinal axis of the device, relative to the striking mechanism when for example one of the drive wheels travels over a bump. Therefore the bump can be travelled over without the rotational movement of the drive unit being transmitted to the striking mechanism. The cutting blade of the striking mechanism therefore rests on the entire surface of the floor even when the device travels over a bump.

It may further be provided in some embodiments that the articulated connection has a rolling bearing and a first joint and a second joint, the first joint being connected to the striking mechanism and to an inner ring of the rolling bearing for conjoint rotation and the second joint being connected to the drive unit and to an outer ring of the rolling bearing for conjoint rotation. A rotational movement of the drive unit relative to the striking mechanism thus causes the outer ring of the rolling bearing to rotate relative to the inner ring of the rolling bearing.

According to some embodiments, it is provided that the articulated connection has an axial locking mechanism of the first and second joint, an end portion of the first joint having a larger circumference than an inner wall of the inner ring and an end portion of the second joint having a smaller circumference than an outer wall of the outer ring. The first joint and the second joint are therefore locked in the longitudinal direction. Furthermore, the articulated connection consisting of the rolling bearing and the first and second joint forms a connection between the drive unit and the striking mechanism.

According to some embodiments, it is provided that the articulated connection has a limiting element which limits a rotation of the drive unit and the striking mechanism relative to one another. Providing the limiting element furthermore ensures that the drive unit and/or the striking mechanism are prevented from tilting sideways in the event of a misalignment.

It may further be provided in some embodiments that the limiting element is designed in the form of a slot which is arranged so as to be adjacent to the articulated connection in a housing wall of the device, the slot being designed so as to be concentric with the articulated connection and a bolt engaging in the slot, which bolt is connected to the drive unit and/or the striking mechanism. The rotation of the drive unit and the striking mechanism relative to one another can thereby be effectively limited.

According to some embodiments, it is provided that the drive unit and the striking mechanism are rotatable relative to one another at an angle of up to 20°, preferably at an angle of up to 15°, particularly preferably at an angle of up to 10°. It can thereby be ensured that when the device travels over smaller to larger bumps the cutting blade of the striking mechanism rests on the entire surface of the floor.

According to some embodiments, it is provided that the first joint is connected to the striking mechanism by a plurality of fastening means, preferably flat headed screws, which screw a housing wall of the striking mechanism to the first joint. Therefore, the striking mechanism can be connected to the first joint in a secure and stable manner.

It may further be provided in some embodiments that the second joint is formed by a housing wall of the drive unit. Therefore, advantageously, additional fastening means for fastening the second joint to the drive unit do not need to be provided.

According to some embodiments, it is provided that the rolling bearing is formed by a double-row deep groove ball bearing. By providing a double-row deep groove ball bearing, good stability of the bearing can be ensured, particularly with respect to absorbing radial forces.

### BRIEF DESCRIPTION OF THE DRAWINGS

Embodiments of the invention are explained in more detail in the following description and illustrated in the figures of the drawings, in which:

FIG. 1 schematically shows the device for removing coverings laid on planar surfaces, according to an embodiment;

FIG. 2 schematically shows the device for removing coverings laid on planar surfaces, according to another embodiment;

FIG. 3 is a cross-sectional view through the device for removing coverings laid on planar surfaces along the section A-A, according to the embodiment shown in FIG. 2;

FIG. 4 is a longitudinal sectional view of the device for removing coverings laid on planar surfaces along a longitudinal axis of the device according to the embodiment shown in FIG. 2;

FIG. 5 is an enlarged view of the device for removing coverings laid on planar surfaces, according to the embodiment shown in FIG. 2.

### DETAILED DESCRIPTION OF EMBODIMENTS OF THE INVENTION

Like reference numerals denote like or functionally like components, unless otherwise stated.

FIG. 1 schematically shows the device for removing coverings laid on planar surfaces, according to an embodiment. The device 1 for removing coverings laid on planar surfaces comprises a drive unit 10, a striking mechanism 20 and an articulated connection 30 for connecting the drive unit 10 and the striking mechanism 20. The drive unit 10 has a pair of drive wheels 12, two first drive motors 14 and a transmission 16 for driving the drive wheels 12, each of the drive motors 14 driving one of the drive wheels 12. The first drive motors 14 are arranged above the transmission 16 in this case.

The striking mechanism 20 has a cutting blade 22, a second drive motor 24 and a connecting rod 25. The cutting blade 22 is connected to the second drive motor 24 by the connecting rod. The second drive motor 24 sets the cutting blade 22 into an impulsive vibrating motion by means of the connecting rod 25 in order to lift the covering.

As can be seen in the embodiment shown in FIG. 1, the two drive wheels 12 rest on the floor when the device 1 is in the working position and drive the device 1 forwards as a result of the floor friction in order to lift a covering from the floor. In this case, the cutting blade 22 lies with its cutting edge on the floor so that it can work between the covering and the floor.

When the device 1 travels over a bump, which can for example occur by means of residues of the covering getting under a drive wheel 12, the drive unit 10 is mounted so as to be rotatable relative to the striking mechanism 20 by providing the articulated connection 30, which connects the drive unit 10 to the striking mechanism 20, as a result of which the drive unit 10 is rotated about an axis of rotation D of the articulated connection 30 which is in parallel with a longitudinal axis of the device 1 and the cutting blade 22 of the striking mechanism 20 rests on the entire surface of the floor.

FIG. 2 schematically shows the device for removing coverings laid on planar surfaces, according to an embodiment. In FIG. 2, the articulated connection 10 is arranged in a lower region of the device 1 in the direction of travel in front of the drive wheels 12 of the drive unit 10, which connection connects the drive unit 10 and the striking mechanism 20 and is suitable for mounting the drive unit 10 and the striking mechanism 20 so as to be rotatable relative to one another.

FIG. 3 is a cross-sectional view through the device for removing coverings laid on planar surfaces along the section A-A, according to the embodiment shown in FIG. 2. The articulated connection 30 has a rolling bearing 32 as well as a first joint 34 and a second joint 36. According to the present embodiment, the rolling bearing 32 is formed by a double-row deep groove ball bearing. Alternatively, another suitable bearing may likewise be provided, for example a plain bearing. The rolling bearing 32 has an inner ring 32a, an outer ring 32b and a plurality of rolling bodies. The first joint 34 is connected to the striking mechanism 20 and to the inner ring 32a of the rolling bearing 32 for conjoint rotation. The second joint 36 is connected to the drive unit 10 and to the outer ring 32b of the rolling bearing 32 for conjoint rotation. When the drive unit 10 rotates relative to the striking mechanism 20, the outer ring 32b of the rolling bearing 32 therefore rotates relative to the inner ring 32a of the rolling bearing 33.

The limiting element 38 is shown in FIG. 3 to the left of the articulated connection 30. The limiting element 38 is designed in the form of a slot 38a which is arranged so as to be adjacent to the articulated connection 30 in a housing wall of the device 1, the slot being designed so as to be concentric with the articulated connection and a bolt 38b engaging in the slot. In this case, the bolt 38b is connected at least to the drive unit 10 or the striking mechanism 20 and may for example be designed as a stud bolt.

The first joint 34 is further connected to the striking mechanism 20 by a plurality of fastening means 40. According to the present embodiment, the fastening means 40 are formed by flat headed screws. By means of the flat headed screws, the striking mechanism 20, in particular a housing wall of the striking mechanism 20, is screwed to the first joint 34.

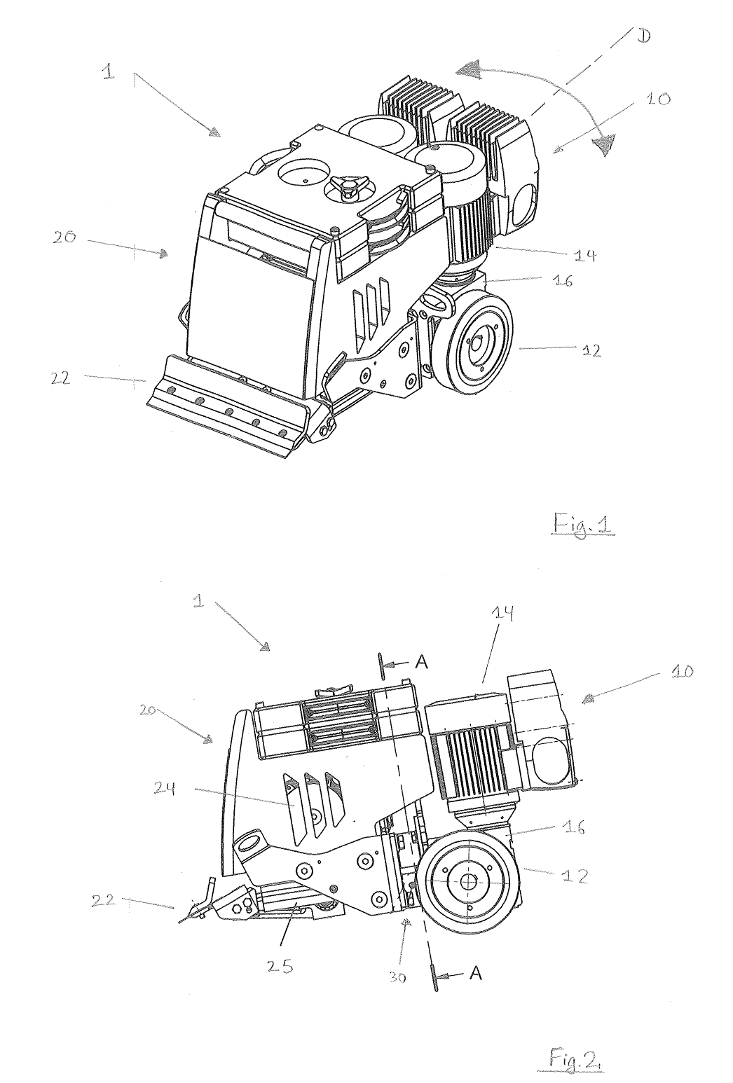

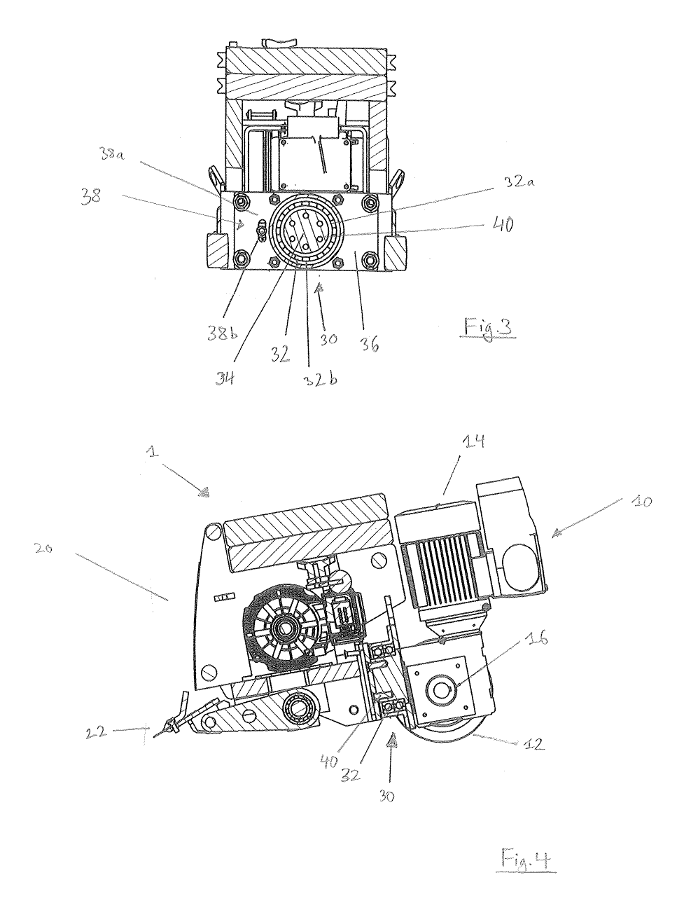

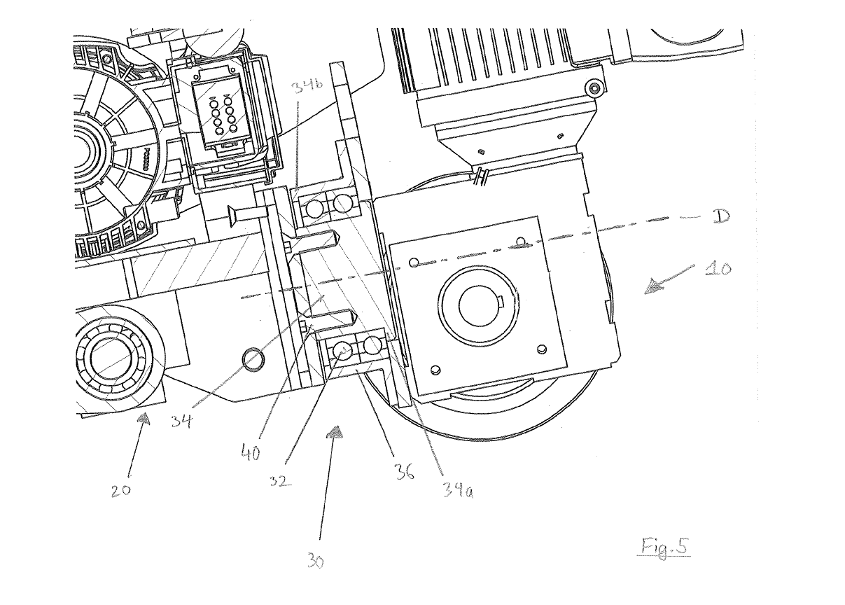

FIG. 4 is a longitudinal sectional view of the device for removing coverings laid on planar surfaces along a longitudinal axis of the device according to the embodiment shown in FIG. 2. The articulated connection 30 is likewise shown in a longitudinal section in FIG. 4. The articulated connection 30, in particular the rolling bearing 32, which is formed by a double-row deep groove ball bearing, and the fastening means 40 for screwing the striking mechanism 20 to the first joint 34 can also be seen in FIG. 4.

FIG. 5 is an enlarged view of the device for removing coverings laid on planar surfaces, according to the embodiment shown in FIG. 2. The articulated connection 30 is shown in greater detail in FIG. 5. The articulated connection 30 comprises the rolling bearing 32 as well as the first joint 34 and the second joint 36. In this case, the first joint 34 is connected to the striking mechanism 20 and to the inner ring 32a of the rolling bearing 32 for conjoint rotation and the second joint 36 is connected to the drive unit 10 and to the outer ring 32b of the rolling bearing 32 for conjoint rotation.

An axial locking mechanism of the first and second joint 34, 36 is furthermore provided. In this case, an end portion 34a of the first joint 34 is provided which has a larger circumference or diameter than an inner wall of the inner ring 32a. An end portion 36a of the second joint 36 has, in this case, a smaller circumference or diameter than an outer wall of the outer ring 32b of the rolling bearing 32. By providing the articulated connection 30, which is formed in such a way that the drive unit 10 and the striking mechanism 20 are mounted so as to be rotatable relative to one another, the drive unit 10 and the striking mechanism are rotatable relative to one another at an angle of up to 10°. Alternatively, the drive unit 10 and the striking mechanism 20 can likewise be rotatable relative to one another at another suitable angle. The fastening means 40, which are formed by flat headed screws, can furthermore be seen in FIG. 5. In total, six flat headed screws are provided, as shown in FIG. 3, only two of the six flat headed screws being illustrated in the view of FIG. 5 in longitudinal section. The flat headed screws screw the housing wall of the bearing 20 to the first joint 34.

The invention is not restricted to the above-mentioned embodiments. Within the scope of protection, the device 1 according to the invention for removing coverings laid on planar surfaces can also, however, assume a configuration other than the configurations specifically described above.

1.-11. (canceled)

1. A device for removing coverings laid on planar surfaces, comprising:
a drive unit having a pair of drive wheels;
a first drive motor for driving the drive wheels;
a motor-driven striking mechanism having a cutting blade; and
a second drive motor, the cutting blade being connected to the second drive motor by a connecting rod,
wherein the drive unit and the striking mechanism have an articulated connection which is designed in such a way that the drive unit and the striking mechanism are mounted so as to be rotatable relative to one another.

2. The device of claim 1 wherein the drive unit and the striking mechanism are mounted so as to be rotatable relative to one another about an axis of rotation of the articulated connection which is in parallel with a longitudinal axis of the device.

3. The device of claim 1 wherein the articulated connection has a rolling bearing as well as a first joint and a second joint, the first joint being connected to the striking mechanism and to an inner ring of the rolling bearing for conjoint rotation and the second joint being connected to the drive unit and to an outer ring of the rolling bearing for conjoint rotation.

4. The device of claim 3 wherein the articulated connection has an axial locking mechanism of the first and second joint, an end portion of the first joint having a larger circumference than an inner wall of the inner ring and an end portion of the second joint having a smaller circumference than an outer wall of the outer ring.

5. The device of claim 1 wherein the articulated connection has a limiting element which limits a rotation of the drive unit and the striking mechanism relative to one another.

6. The device of claim 5 wherein the limiting element is designed in the form of a slot which is arranged so as to be adjacent to the articulated connection in a housing wall of the device, the slot being designed so as to be concentric with the articulated connection and a bolt engaging in the slot, which bolt is connected to the drive unit and/or the striking mechanism.

7. The device of claim 6 wherein the drive unit and the striking mechanism are rotatable relative to one another at an angle of up to 20°.

8. The device of claim 3 wherein the first joint is connected to the striking mechanism by a plurality of flat headed screws, which screw a housing wall of the striking mechanism to the first joint.

9. The device of claim 3 wherein the second joint is formed by a housing wall of the drive unit.

10. The device of claim 3 wherein the rolling bearing is formed by a double-row deep groove ball bearing.

11. The device of claim 7 wherein the drive unit and the striking mechanism are rotatable relative to one another at an angle of up to 15°.

12. The device of claim 11 wherein the drive unit and the striking mechanism are rotatable relative to one another at an angle of up to 10°.
